(19) United States
(12) Patent Application Publication
(10) Pub. No.: US 2003/0030747 A1
(43) Pub. Date: Feb. 13, 2003

(54) Microscope with digital camera

(75) Inventors: Po-Ching Lu, Pingdong (TW); Anchi Yu, Hsinchu (TW); King-Yuen Chang, Wu-Gu (TW); Jian-Ming Peng, Hsinchu (TW)

Correspondence Address: LOWE HAUPTMAN GOPSTEIN GILMAN & BERNER, LLP, Suite 310, 1700 Diagonal Road, Alexandria, VA, 22314, US

(73) Assignee: Mustek Systems, Inc.

(21) Appl. No.: 10/015,652

(22) Filed: Dec. 17, 2001

(30) Foreign Application Priority Data
Aug. 8, 2001 (TW) 90213439

(51) Int. Cl. H04N 5/225

(52) U.S. Cl. 348/373

(57) ABSTRACT

This invention relates to a microscope combined with a digital camera that the user can use to obtain the enlarged digital image of an observed tiny object directly. The microscope combined with a digital camera comprises a base, a support section, a movable camera bracket, a light source, and a lens tube section; wherein the base is used to support the microscope, on which can be placed an observed object, the support section is connected to the base and the movable camera bracket which the digital camera is fixed onto can be slipped up and down along the support section. The user can use to obtain the digital image by the lens tube section, which is to enlarge the image of the observed tiny object, and the light source provides the light for observing the observed tiny object.

### BACKGOUND OF THE INVEINTION

1. Field of the Invention

This invention relates to a microscope and, more particularly, it relates to a microscope specifically combined with a digital camera that the user can use to obtain the enlarged image of an observed object directly.

2. Description of Related Art

Digital camera has been developed for many years, whose main function is to directly get and translate the image into digital data for decreasing the inconvenient of translating the image data. Therefore many image workers, homepage designer or the ordinary users are favorable to use this device.

However, the general use of the digital camera is only to take pictures of general scenery. The digital camera is going to save digital data after using it to take picture of scenery and the user needs a computer to output and edit the saved digital data, as shown in FIG. 1, the digital camera 1 is connected to a computer 2 by a transmission line 12, the computer 2 needs to be installed in advance the relative software program (not shown in the FIG. 1), the pictures shown in a digital display screen 10 of the digital camera 1 are transmitted into the computer 2 and shown in the computer display screen 20 by the instruction of the relative software program, then the user can edit the pictures by using of the editing software of the computer 2.

The general application of the digital camera of the prior art as described above. It is very convenient to use the digital camera but if the object that the user wants to take tiny picture, such as germs, hairs, the general digital camera cannot provide this kind of function.

### SUMMARY OF THE INVENTION

The objective of the present invention is to provide a microscope combined with a digital camera that the user could get the enlarged image of an observed tiny object directly.

The microscope combined with a digital camera of the present invention comprises a base, a support section, a movable camera bracket, a light source, and a lens tube section. The base is used to support the microscope, on which can be placed an observed object and the upper surface of the base has the fixed clips to fix the observed object for preventing the observed object moved. The support section is connected to the base by one end and the movable camera bracket can be slipped up and down along the support section. The movable camera bracket further comprise a bracket fixed unit and a camera fixed unit, wherein the bracket fixed unit can fix the movable camera bracket onto the support section, and the camera fixed unit is at the upper surface of the movable camera bracket, which can fix the digital camera onto the movable camera bracket. The light source is under the movable camera bracket that provides the light for observing the observed object. The lens tube section is between the digital camera and the base, which is to enlarge the image of the observed tiny object.

### BRIEF DESCRIPTION OF THE DRAWING

FIG. 1 is a perspective view of the digital camera of the prior art;

FIG. 2 is a perspective view of the microscope combined with a digital camera of the present invention;

FIG. 3A is a disassembled vertical cross section of the first embodiment of the microscope combined with a digital camera of the present invention;

FIG. 3B is a assembled vertical cross section of the first embodiment of the microscope combined with a digital camera of the present invention;

FIG. 3C is a vertical cross section of the first camera fixed unit of the microscope combined with a digital camera of the present invention;

FIG. 3D is a vertical cross section of the second camera fixed unit of the microscope combined with a digital camera of the present invention;

FIG. 3E is a vertical cross section of the third camera fixed unit of the microscope combined with a digital camera of the present invention;

FIG. 4A is a disassembled vertical cross section of the second embodiment of the microscope combined with a digital camera of the present invention;

FIG. 4B is a assembled vertical cross section of the second embodiment of the microscope combined with a digital camera of the present invention;

FIG. 5 is a vertical cross section of the third embodiment of the microscope combined with a digital camera of the present invention;

FIG. 6 is a vertical cross section of the fourth embodiment of the microscope combined with a digital camera of the present invention;

### DETIALED DESCRIPTION OF PREFERRED EMBODIMENT

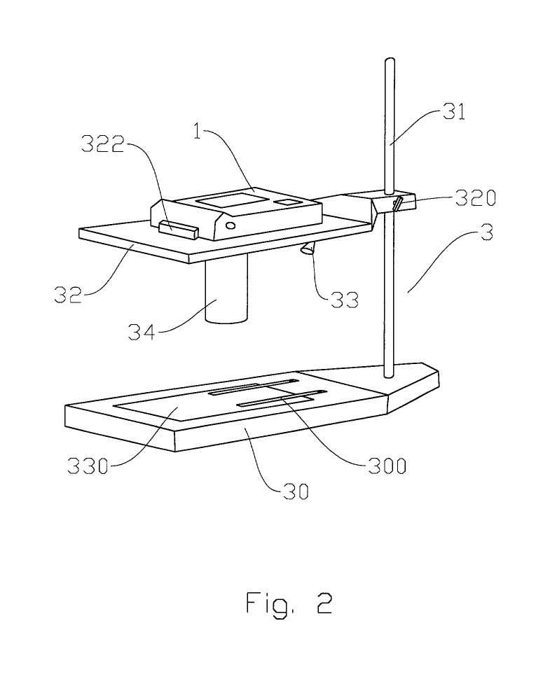

The microscope combined with a digital camera of the present invention as shown in FIG. 2, which is a perspective view of the present invention. The microscope combined with a digital camera 3 has a base 30, a support section 31, a movable camera bracket 32, a light source 33, and a lens tube section 34; wherein the base 30 is used to support the microscope, on which can be placed an observed object (not shown in the FIG. 2). The surface of the base 30 has the fixed clips 300 to fix the observed object, so the observed object will not be moved while operating the digital camera 1. The support section 31 is in a cylinder club shape, which is connected to the base 30 by one end. The movable camera bracket 32 is connected movably to the support section 31 to make the movable camera bracket 32 can be slipped up and down along the support section 31. The movable camera bracket 32 further comprise a bracket fixed unit 320 and a camera fixed unit 322, wherein the bracket fixed unit 320 can fix the movable camera bracket 32 onto the support section 31, and the camera fixed unit 322 is at the upper surface of the movable camera bracket 32, which can fix the digital camera 1 onto the movable camera bracket 32. The light source 33 is under the movable camera bracket 32 that provides the light for observing the observed object. The lens tube section 34 is between the digital camera 1 and the base 30, which is to enlarge the image of the observed object.

Owing to the microscope combined a digital camera of the present invention 3 fixes the digital camera 1 onto the movable camera bracket 32, the observed object can be enlarged by the lens tube section 34 for an digital image being gotten and output, then the user obtains directly an enlarged digital image of a tiny observed object. For solving the lack-of-light problem, this invention use the light source 33 to light up the observed object to overcome the disadvantage; the electricity that the light source 33 needs can be provided by the battery sets inside the microscope or by the electric sockets inside the house (110 voltage). The preferred embodiment of the integration of the present invention described as follow:

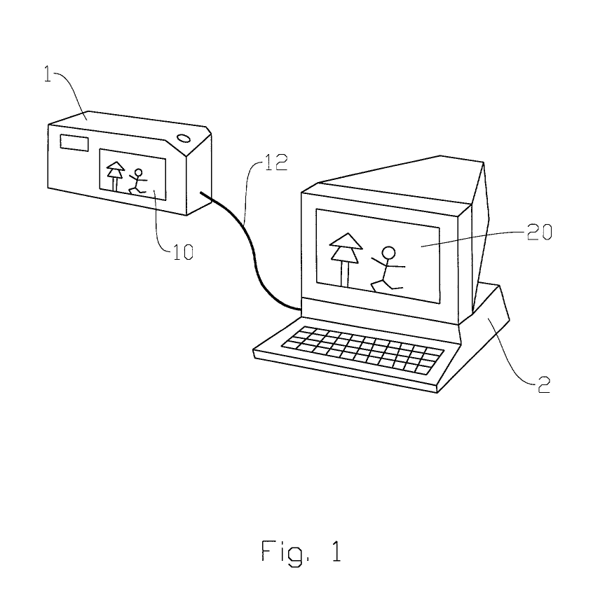

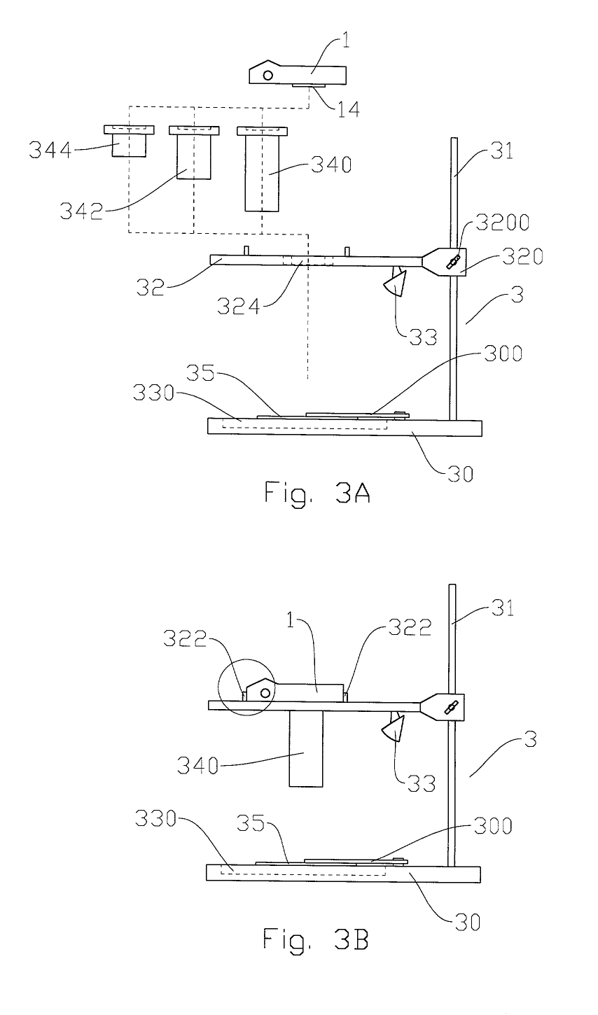

The first preferred embodiment of this invention as shown in FIG. 3A & 3B, there are several lens tubes with different magnifying factors, such lens tube with high magnifying factor 340, lens tube 342 with medium magnifying factor, lens tube with low magnifying factor 344, the top of the lens tubes aforementioned can be connected directly to the lens 14 of the digital camera 1, which can be fixed tightly by a screw, the user can arbitrarily choose the magnifying factor depending on the condition. The preferred embodiment is explained by example of the lens tube with high magnifying factor 340, which is connected to the lens 14 and pass through one hole 324 of the movable camera bracket 32, when the digital camera 1 is placed on the upper surface of the movable camera bracket 32, the camera fixed unit 322 fixed the digital camera 1 onto the movable camera bracket 32. The user places the extremely tiny observed object 35 on the base 30 and fixes it by the fixed clips 300, then turn on the light source 33 to light up the observed object 35 to get the light as needed; besides, the user can slip the movable camera bracket 32 up and down along the support section 31 for adjusting the focus distance and fix the movable camera bracket 32 by the bracket fixed unit 320 to gain the clear image. The bracket fixed unit 320 is a knob 3200 passing through one screw hole of the movable camera bracket 32 (not shown in the FIG. 3A & 3B) and toughing tightly against the support section 31 to fix the movable camera bracket 32 to any part of the support section 31 as will. As shown in FIG. 3 B, the user can operate the digital camera 1 as the prior art to take picture of the image of the observed object 35 and transfer it into digital data and output directly, or connect to the computer 2 (as shown in FIG. 1), the image of the observed object 35 can be display on the monitor 20 of the computer 2 directly by the relative software program.

Referring to FIG. 3C now, it is a vertical cross section of the first camera fixed unit as aforementioned to fix the digital camera 1 onto the movable camera bracket 32, the fixed chain 3220 is an elastomer with pillar shape, whose bottom is connected to the upper surface of the movable camera bracket 32, can placed at two opposite sides of the digital camera 1. When the digital camera 1 is placed on the movable camera bracket 32, the fixed end 32200 of the fixed chain 3220 will insert into the fixed hole 16, which is at the corresponding side of the digital camera 1, to fix the digital camera 1 onto the movable camera bracket 32. If the user wants to take away the digital camera 1, he can pull outside the released end 32202 of the fixed chain 3220 directly as the direction of the arrow shown in FIG. 3C to make the fixed end 32200 leave the fixed hole 16, then the digital camera 1 leaves the movable camera bracket 32.

In addition, as shown in FIG. 3D, it is a vertical cross section of the second camera fixed unit, which uses a fixed screw 3222 to fix the digital camera 1 onto the movable camera bracket 32 by passing through a fixed blocking plate 3224 to lock in one screw hole of the digital camera 1; or uses the third camera fixed unit as shown in FIG. 3E to achieve the same purpose by a fixed screw 3222 passing through the movable camera bracket 32 to fix the digital camera 1. If the observed object 35 is a transparent object or translucent object, the base 30 of the present invention has a light-conduct plate 330 which is a device on the upper surface of the base 30 to provide the light distribute uniformly to observe object 35.

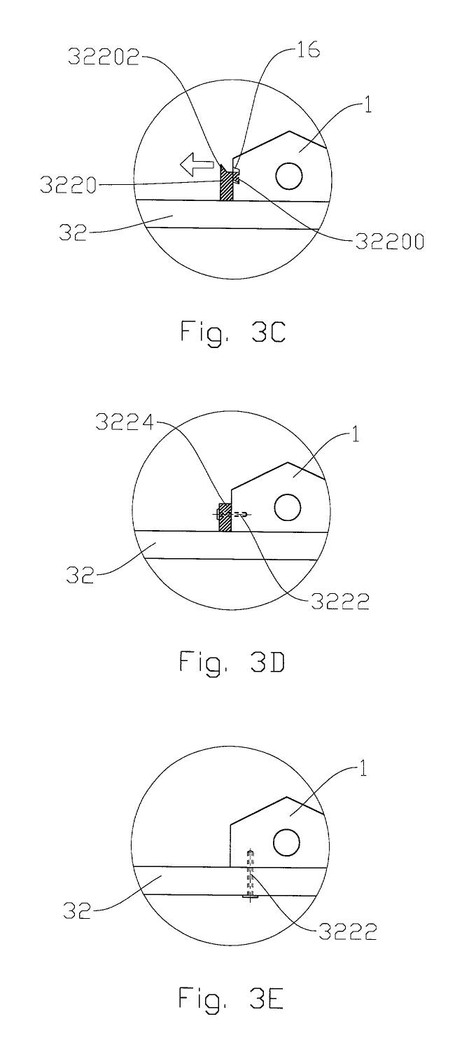

As shown in the FIG. 4A, it is the second preferred embodiment of the present invention. The components of this preferred embodiment is as same as those listed in the first preferred embodiment, the difference is only the several lens tubes with different magnifying factors are connected directly to the connection 326 at the bottom of the movable camera bracket 32 (which can be fixed by the screw bolt), then put the digital camera 1 on the upper surface of the movable camera bracket 32, the assembly as shown in FIG. 4B, the operation is as same as those described in the first preferred embodiment.

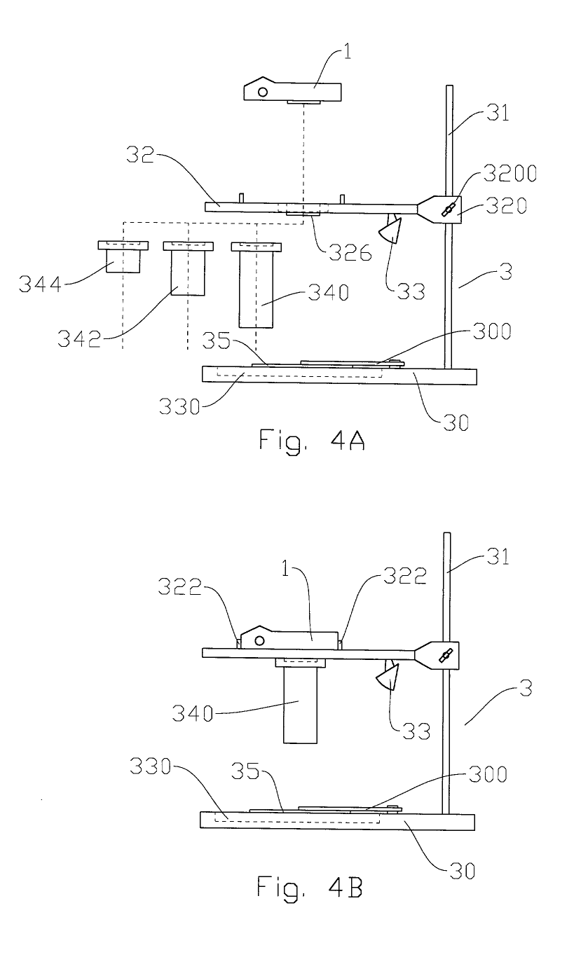

Referring to FIG. 5, which is the third preferred embodiment of the present invention. In this preferred embodiment, the lens tube aforementioned is replaced by a set of rotating multi-lens 346 which has several lens tubes with different magnifying factors; the user can get magnifying factor as needed by turning the rotating unit 3460 to change the lens tubes. Of course, the center of the lens tube must be focus on the center of the lens 14 of the digital camera 1.

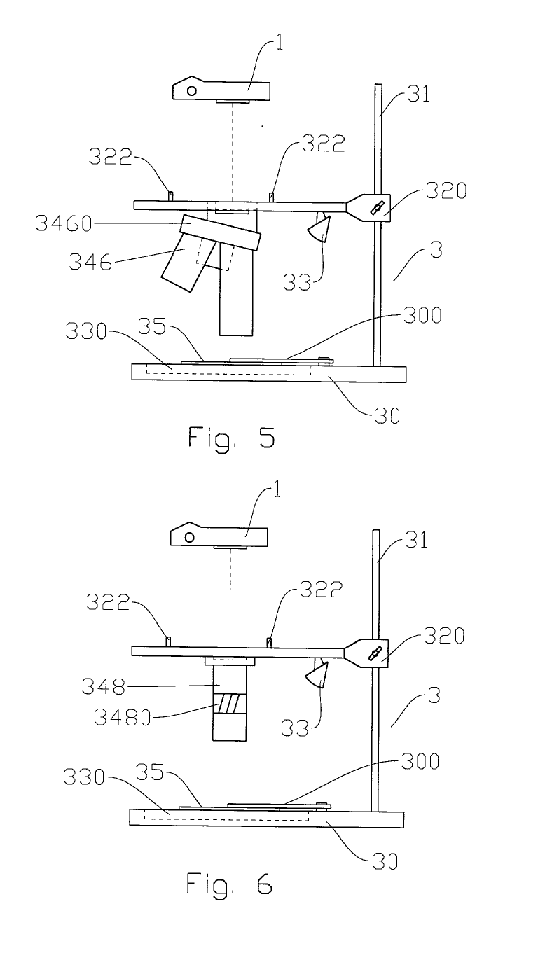

As shown in FIG. 6, it is the fourth preferred embodiment of the present invention. This preferred embodiment uses a lens tube with adjusting focus 348 to replace the lens tubes aforementioned; the lens tube with adjusting focus 348 has a focus adjusting system to adjust the magnifying factor for observing the image of the observed object to achieve the purpose mentioned above.

The embodiments described above are the preferred embodiments to explain but limit the scope of the present invention, the scope of the present invention is defined by the claims described as follow. The variations and /or modifications according to the claims of the present invention should be contained by the present invention.

What claim is:

1. A microscope combined with a digital camera comprising:
a base which an observed object is placed upon;
a support section being connected to said base;
a movable camera bracket which is connected to said support section having:
a bracket fixed unit which fixes said movable camera bracket to said support section;
a camera fixed unit being on the upper surface of said movable camera bracket for fixing said digital camera onto said movable camera bracket;
a lighting section being to provide the light for observing said observed object;
a lens tube section, between said digital camera and said base, which enlarges the image of said observed object.

2. The microscope according to claim 1, wherein said base further comprises a fixed clip to fix said observed object.

3. The microscope according to claim 2, wherein said fixed clip is an elastomer with long strip shape.

4. The microscope according to claim 3, wherein one end of the said fixed clip is fixed onto said base.

5. The microscope according to claim 1, wherein said bracket fixed unit is a knob to fix said movable camera bracket to said support section by passing though a screw hole of said movable camera bracket to touch tightly said support section.

6. The microscope according to claim 1, wherein said camera fixed unit is a fixed chain whose one end is connected said digital camera and the other end is fixed onto said movable camera bracket.

7. The microscope according to claim 1, wherein said camera fixed unit is a fixed screw to be fixed in a screw hole of said digital camera by passing through said movable camera bracket.

8. The microscope according to claim 1, wherein said camera fixed unit is a fixed screw to be fixed in a screw hole of said digital camera by passing through a fixed blocking plate.

9. The microscope according to claim 1, wherein said camera fixed unit is a fixed screw to be fixed in a screw hole of said digital camera by passing through a fixed member.

10. The microscope according to claim 1, wherein said lighting section is a light-conduct plate above said base to provide the light for said observed object.

11. The microscope according to claim 1, wherein said lighting section is a light source above said base to provide the light for said observed object.

12. The microscope according to claim 1, wherein said lens tube section is connected to a lens of said digital camera.

13. The microscope according to claim 1, wherein said lens tube section is connected to the bottom of said movable camera bracket.

14. The microscope according to claim 1, wherein said lens tube section is a set of rotating multi-lens, which locates under said movable camera bracket.

15. The microscope according to claim 1, wherein said lens tube section is a lens tube with adjusting focus, which locates under said movable camera bracket.

16. The microscope according to claim 15, wherein said lens tube with adjusting focus further comprises a focus adjusting system to adjust the magnifying factor of said lens tube with adjusting focus.
